(19) United States
(12) Patent Application Publication
(10) Pub. No.: US 2005/0184605 A1
(43) Pub. Date: Aug. 25, 2005

(54) Cooling fan having three-phase DC motor

(76) Inventors: Wade D. Vinson, Magnolia, TX (US); John P. Franz, Houston, TX (US); Stephen E. Sidle, Houston, TX (US); Mark A. Lawrence, The Woodlands, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/783,167

(22) Filed: Feb. 20, 2004

(51) Int. Cl. H02K 7/00; H02K 5/16; H02K 15/00

(52) U.S. Cl. 310/68 R; 310/67 R; 29/596; 310/90

(57) ABSTRACT

A cooling fan having a three-phase DC motor. The three-phase DC motor is coupled to a fan impeller. The cooling fan is operable to induce a flow of air through an electronic device. The cooling fan may be a redundant, hot-plug cooling fan for operation within the electronic device.

### BACKGROUND OF THE RELATED ART

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Electronic devices typically consist of a variety of electrical components. These components may generate substantial amounts of heat that can damage or inhibit the operation of the electronic device. Consequently, electronic devices commonly use cooling fans to remove heat generated within the electronic device by the electrical components.

### BRIEF DESCRIPTION OF THE DRAWINGS

Exemplary embodiments of the present invention may be apparent upon reading of the following detailed description with reference to the drawings in which:

FIG. 1 is a perspective view illustrating a server in accordance with embodiments of the present invention;

FIG. 2 is a perspective view of a portion of the server of FIG. 1 illustrating an exemplary redundant cooling fan system in accordance with embodiments of the present invention;

FIG. 3 is a front elevation view illustrating a cooling fan with a three-phase DC motor in accordance with embodiments of the present invention;

FIG. 4 is a side elevation view of the cooling fan of FIG. 3 in accordance with embodiments of the present invention;

FIG. 5 is a perspective view illustrating the stator of the three-phase DC motor of the cooling fan of FIG. 3 in accordance with embodiments of the present invention;

FIG. 6 is a rear elevation view of the impeller of the cooling fan of FIG. 3 in accordance with embodiments of the present invention;

FIG. 7 is a block diagram of the three-phase DC motor of the cooling fan of FIG. 3 in accordance with embodiments of the present invention;

FIG. 8 is an elevation view of the bottom of the circuit board of the motor controller of the cooling fan of FIG. 3 in accordance with embodiments of the present invention;

FIG. 9 is an elevation view of the top of the circuit board of the motor controller of the cooling fan of FIG. 3 in accordance with embodiments of the present invention; and

FIGS. 10A and 10B are elevation views of conductive layers of the circuit board of the motor controller of the cooling fan of FIG. 3 in accordance with embodiments of the present invention.

### DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

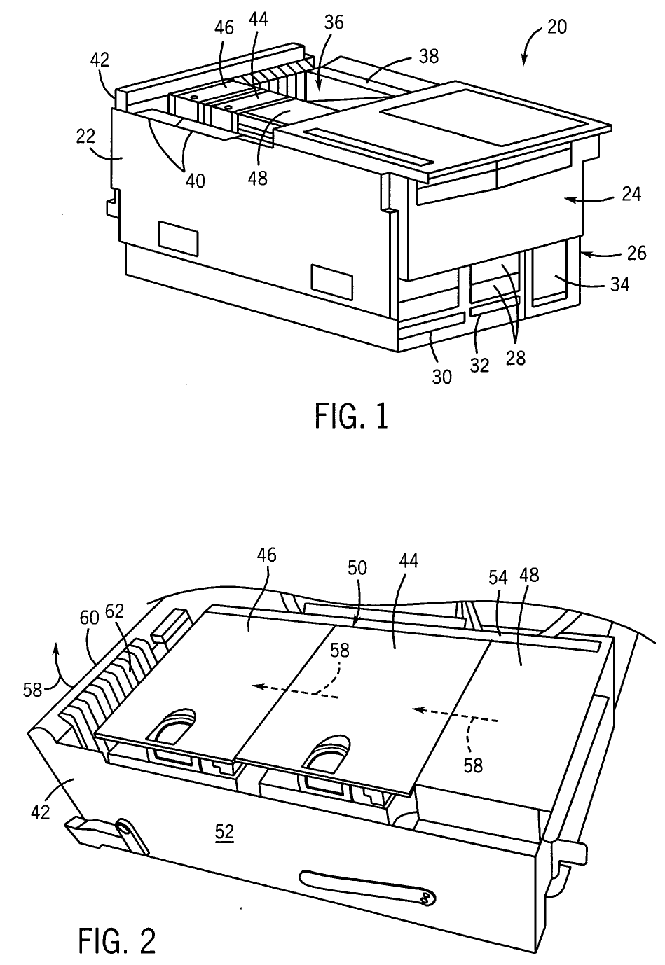

Referring generally to FIG. 1, an electronic device 20 is illustrated. In the illustrated embodiment, the electronic device 20 is a server. A server is a computer that provides services to other computers. For example, a file server is a computer that stores files that may be accessed by other computers via a network. Another type of server is an application server. An application server is a computer that enables other computers to perform large or complicated tasks. However, the techniques described below may be applicable to electronic devices other than servers, such as other types of computers, televisions, etc.

The illustrated server 20 has a chassis 22 that supports the components of the server 20. One of the components of the server 20 that is supported by the chassis 22 is a processor module 24 that houses a plurality of processors. The processor or processors in processor module 24 enable the server 20 to perform its intended functions, such as functioning as a file server or as an application server. To perform these functions, the processor module 24 processes data from various sources. Some of these sources of data are housed within a memory module 26. The memory module 26 may comprise one or more data storage devices that are operable to store data and transmit the data to the processors in the processor module 24. In this embodiment, the data storage devices comprise several hard disk drives 28, a CD-ROM drive 30, and a diskette drive 32. However, the memory module 26 may comprise other data storage devices. The illustrated server 20 also comprises a control panel 34 to enable a user to monitor and control various server functions.

Another component that may be supported by the chassis 22 is an Input/Output (“I/O”) module 36. The I/O module 36 is adapted to receive a plurality of I/O cards 38 for communicating with other computers and electronic devices via a network, such as the Internet. The I/O cards 38 enable data to be transferred between the processor module 24 and external devices via the network. In addition, the illustrated I/O module 36 houses one or more power supplies, such as a pair of power supplies 40. In the illustrated embodiment, the power supplies 40 are redundant, i.e., one of the power supplies 40 is operating at all times and the other power supply is idle, but ready to operate if requested by the server 20. In addition, the power supplies 40 are hot-pluggable, i.e., the power supplies 40 may be removed and installed while the server 20 is operating. In this embodiment, the I/O module 36 has its own chassis 42 that is disposed within the server chassis 22.

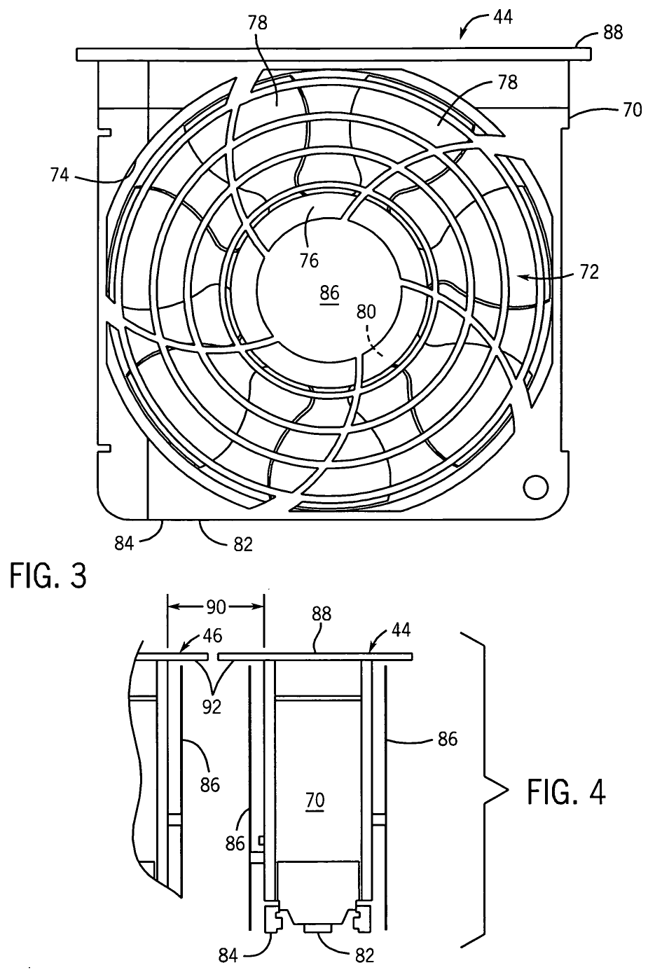

Referring generally to FIGS. 1 and 2, a first fan 44 and a second fan 46 are provided to produce a flow of air to cool the components housed within the server 20. The server 20 is operable to control the operation of the first fan 44 and the second fan 46. In this embodiment, the first fan 44 and the second fan 46 are identical. In addition, the first fan 44 and the second fan 46 are redundant fans. As with the power supplies 40, one fan may be operating at all times, while the other fan is idle. Thus, at any point in time, either the first fan 44 or the second fan 46 is operating. When a problem occurs with the operating fan, the server 20 starts the idle fan. However, the server 20 may be configured to operate both the first fan 44 and the second fan 46 at the same time. In addition, the first fan 44 and the second fan 46 are each hot-pluggable, i.e., they may be removed and installed with the server 20 operating.

As best illustrated in FIG. 2, the first fan 44 and the second fan 46 are oriented in series. A shroud 48 is provided to direct air into the first fan 44. The first fan 44 and the second fan 46 define a fan tunnel 50 that directs the flow of air through the fans. The fan tunnel 50 also comprises a side 52 of the I/O module chassis 42 and a partition 54 that extends along the sides of the first fan 44 and second fan 46. Depending upon which of the two fans is operating, either the first fan 44 is blowing air 58 through the second fan 46 or the second fan 46 is drawing air 58 through the first fan 46. The operating fan draws air 58 into the server 20, cooling the components housed therein. The warm air is blown out of the server 20 through ventilation holes 60 on the rear side of the I/O module chassis 42. In addition, an outlet guard 62 may be disposed on the inner side of the ventilation holes 60.

Referring generally to FIG. 3, the first fan 44 is illustrated. As noted above, the first fan 44 and the second fan 46 are identical in this embodiment. Therefore, for simplicity, only the first fan 44 is discussed below. The first fan 44 comprises a fan housing 70 and an impeller 72 that rotates within an inner cylindrical portion 74 of the fan housing 70. In the illustrated embodiment, the impeller 72 has a central hub 76 and seven blades 78 that extend outward from the central hub 76 towards the inner cylindrical portion 74 of the fan housing 70. The impeller 72 is rotated by a three-phase DC motor 80 that is housed within the hub 76. A three-phase DC motor is more efficient than a conventional DC motor, which enables the first fan 44 and the second fan 46 to produce a larger flow of air than a comparable cooling fan of the same size that uses a conventional DC motor. A conventional DC motor used in a cooling fan has an efficiency of approximately fifty percent. A three-phase DC motor has an efficiency of approximately seventy percent. As will be discussed below, a number of problems had to be overcome to enable a three-phase DC motor 80 to be utilized in a cooling fan used in a server 20.

Referring generally to FIGS. 3 and 4, the first fan 44 has an electrical connector 82 that is disposed on a bottom side 84 of the fan housing 70. The electrical connector 82 enables power and control signals to be transmitted to the three-phase DC motor 80 when the first fan 44 is inserted into the server 20. In addition, each fan may include a guard 86 on each side of the impeller 72 to prevent objects from being inserted into the blades 78 of the impeller 72. The guards 86 are displaced at a distance from the impeller 72. This displacement reduces the resistance to air flow caused by the guards 86. In addition, the guards 86 have an air foil shape that further reduces the resistance to air flow caused by the guards 86. Each fan housing 70 also has a top piece 88 that extends over the guards 86 and defines the top of the fan tunnel 50.

As illustrated in FIG. 4, a gap 90 is provided between the impellers 72 of the two first fan 44 and the second fan 46 to enable the air 58 to stabilize before it enters the second fan 46, reducing air resistance further. The top 88 of each fan housing 70 has an overhang 92 that covers the gap 90 between the first fan 44 and the second fan 46 to prevent air from being diverted into the server 20, rather than to the second fan 46. The impeller 72 of the idle fan may be able to spin freely, because the resistance to the flow of air of a non-operating fan is typically greater when the impeller 72 is locked than it is when the impeller 72 is able to spin freely.

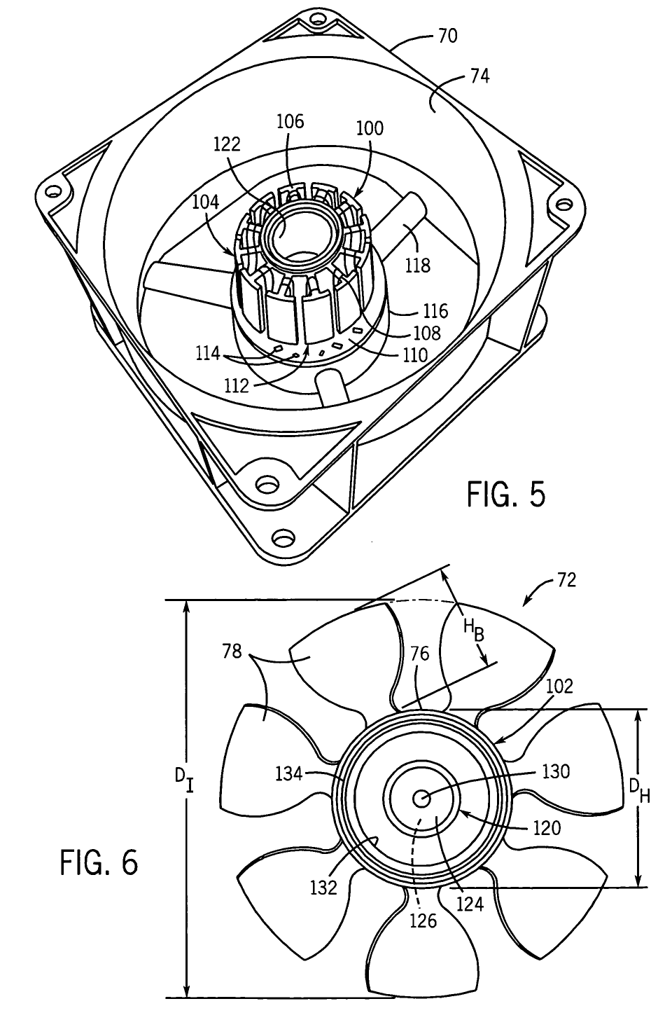

Referring generally to FIGS. 5 and 6, the three-phase DC motor 80 comprises a stator 100 secured to the fan housing 70 and a rotor 102 secured to the fan impeller 72. The stator 100 produces a magnetic field that induces rotation in the rotor 102, thus causing the impeller 72 to rotate. As illustrated in FIG. 5, the stator 100 comprises a stator core 104 formed of a stack of laminations. The illustrated stator 100 has twelve poles 106. Each pole 106 has a winding 108 that produces a magnetic field when electricity flows through the winding. The windings 108 are coupled together to form three groups or phases. The stator 100 of the three-phase DC motor 80 is mounted on an annular circuit board 110. A motor controller 112 for the three-phase DC motor 80 also is mounted on the circuit board 110. The motor controller 112 selectively energizes the three groups or phases of the windings to produce a rotating magnetic field to induce rotation of the rotor 102 and the impeller 72.

The motor controller 112 has a plurality of electronic components 114 that are mounted on the circuit board 110. The circuit board 110 may be secured to a hub 116 of the fan housing 70. In this embodiment, the hub 116 is secured to the fan housing 70 by three support arms 118. The motor controller 110 has various inputs and outputs that are electrically coupled to the electrical connector 82 disposed on the bottom 84 of the fan 44, as illustrated in FIG. 3. These inputs and outputs enable the server 20 to send power and control signals to the fans 44 and 46 to receive data signals from the fans 44 and 46.

As illustrated in FIG. 6, a bearing assembly 120 is provided to support the rotor 102 and to enable the rotor 102 to rotate relative to the stator 100. The bearing assembly 120 is inserted within a cylindrical surface 122 disposed within the stator core 104. The bearing assembly 120 has a first bearing 124 and a second bearing 126. The fan impeller 72 has a shaft 130 that extends through and is supported by the first bearing 124 and the second bearing 126, enabling the fan impeller 72 to rotate freely relative to the fan housing 70. The shaft 130 in the illustrated embodiment is larger in diameter than comparable shafts in other similar sized cooling fan motors. Therefore, the first bearing 124 and second bearing 126 are larger in size than conventional bearings used in cooling fans. In particular, the first and second bearings have a larger ratio of the outer diameter of the bearing to the inner diameter of the bearing than in previous cooling fans. Typically, the ratio of the outer diameter of a bearing to the inner diameter of the bearing in a cooling fan is approximately 2.81. However, in the illustrated embodiment, the ratio of the outer diameter of the bearing to the inner diameter of the bearing is approximately 3.19. The larger ratio enables the bearings to have a larger volume, which enables the bearing to have a greater number of bearing elements within the bearing and increases the bearing surface area which reduces friction. This also enables a greater amount of grease to be placed within the bearings, further reducing friction. In addition, high performance grease may be used. As a result, the life of the first bearing 124 and the second bearing 126 has been increased to about 150,000 hours as compared to about 40,000 hours for a typical bearing.

The rotor 102 may comprise a rare earth magnet 132. In the illustrated embodiment, the rare earth magnet 132 is a bonded neodymium-iron-boron magnet and has eight poles. As noted above, the stator 100 produces a rotating magnetic field that induces rotation of the magnet 132. The magnet 132 is secured to the hub 76. Thus, as the magnet 132 rotates, the hub 76 and blades 78 of the impeller 72 rotate. The rotation of the blades 78 of the impeller 72 induces the flow of air through the fan. The bonded neodymium-iron-boron magnet 132 does not produce cogging torque and increases the efficiency of the motor by approximately eight percent. Cogging torque is generally undesirable because it interferes with the rotation of the rotor 102, making the motor 80 less efficient. Cogging torque occurs when the rotor poles try to align with the stator poles.

One factor that affects the flow of air that is produced by the impeller 72 is the blade height (“H_{B}”). The height of the blades is limited by the diameter of inner cylindrical portion 74 of the fan housing 70 and the hub diameter (“D_{H}”) of the fan impeller 72. The hub diameter is defined by the size of the motor to be housed therein. The greater efficiency of a three-phase DC motor over a conventional DC motor enables a three-phase motor DC motor to produce the same power as a conventional DC motor but in a smaller volume. In addition, the gap 134 between the outer diameter of the magnet and the inner diameter of the hub 76 also is minimized to reduce the outer diameter of the hub 76. Thus, the hub 76 in the illustrated embodiment is smaller in diameter than a comparable fan that uses a single-phase DC motor. In the illustrated embodiment, the first fan 44 is a 5.5 inch by 5.5 inch cooling fan. However, the present techniques are applicable to fans of all sizes. The impeller diameter (“D_{I}”) in the illustrated embodiment, and in a typical impeller for a 5.5 inch by 5.5 inch cooling fan, is 5.25 inches. In a typical cooling fan using a conventional DC motor, the hub diameter is approximately 3.13 inches. Thus, each blade is approximately 1.06 inches. However, the hub diameter (“D_{H}”) of the illustrated 5.5 inch by 5.5 inch cooling fan is 2.56 inches and the blade height (“HB”) is 1.35 inches long. As a result, the blade height (“H_{B}”) in the illustrated embodiment is approximately 25% of the impeller diameter (“D_{I}”), as compared to 20% of the impeller diameter in a fan using a conventional DC motor. This enables the impeller 72 to displace a greater amount of air for each rotation of the impeller than an impeller of a comparable fan powered by a conventional DC motor.

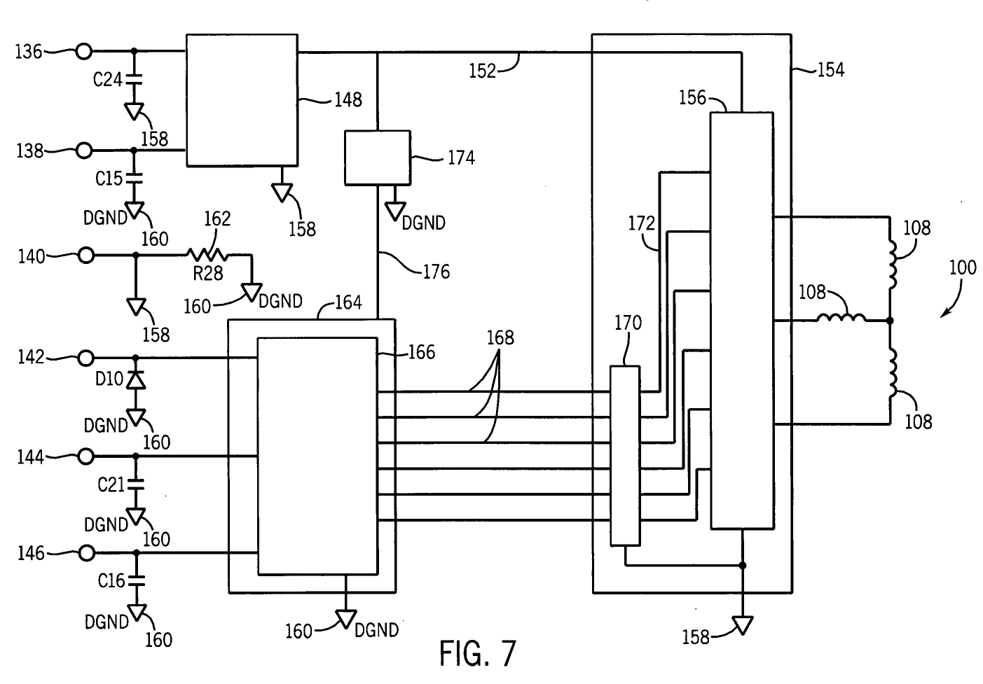

Referring generally to FIG. 7, an electrical schematic of the motor 80 and motor controller 112 is illustrated. In the illustrated embodiment, the circuit board 110 has six I/O terminals: a first terminal 136, a second terminal 138, a third terminal 140, a fourth terminal 142, a fifth terminal 144, and a sixth terminal 146. The terminals are electrically coupled by the electrical connector 82 illustrated in FIG. 4 to the server 20. I/O terminals 136, 138, 140, and 142 enable the motor controller 112 to receive power and control signals from the server 20. In addition, terminals 138, 144, and 146 enable data to be transmitted to the server 20 from the motor controller 112.

Because the fans 44 and 46 are hot-plug fans, the first terminal 136 is coupled directly to 12 VDC power from the server 20 as soon as the first fan 44 is installed within the server 20. The motor controller 112 converts the 12 VDC power into a three-phase DC signal that is coupled to the windings 108 of the stator 100. It has been discovered that applying the full 12 VDC to the portions of the motor controller 112 that produce the three-phase DC power will cause a surge of power to be drawn from the server 20. This surge of power from the server 20 may adversely effect the operation of the server 20. To address this concern, the motor controller 112 may include a slow-start circuit 148 to ramp up the voltage from the server 20. The slow-start circuit 148 controls the rise of voltage from the first terminal 136 to a 12 VDC bus 152. When the first fan 44 is installed in the server 20, the second terminal 138 is coupled to a pull-up circuit (not shown) in the server 20. The voltage causes the slow-start circuit 148 to slowly begin conducting the 12 VDC from the first terminal 136 to the 12 VDC bus 152, ramping the voltage from 0 VDC to 12 VDC. In addition, when the second terminal 138 is coupled to the pull-up circuit (not shown) in the server 20, the voltage in the pull-up circuit drops, providing a signal to the server 20 to indicate that the fan is installed.

The 12 VDC bus power is converted by a switching circuit 154 into a three-phase DC signal. The switching circuit 154 comprises a plurality of semiconductor switching devices 156 (“Q1-Q6”). By selectively switching the semiconductor switching devices 156, the 12 VDC power on the 12 VDC bus is converted to three-phase DC. In the illustrated embodiment, the semiconductor switching devices 156 are field effect transistors (“FETs”).

It has been discovered that the semiconductor switching devices 156 produce electrical noise that can travel over an electrical ground and interfere with the operation of the motor controller 114. To address this concern, in the illustrated embodiment, the switching circuit 154 is electrically coupled to a first ground path and other electrical components are coupled to a second ground 160 (“DGND”). This prevents electrical noise from the switching circuit 154 from interfering with other components, especially those components sensitive to electrical noise, such as processors. For example, the second ground 160 prevents electrical noise on the first ground 158 from being coupled to the second terminal 138 and thereby providing a false indication to the server 20 that the fan has failed or that the fan is not installed. The third terminal 140 of the motor controller 112 couples the first ground 158 and the second ground around 158, 160 to a server ground when the fan is installed in the server 20. The second ground 160 is coupled to the third terminal 140 via a resistor (“R28”) 162. The resistor 128 electrically isolates the first ground 158 from the second ground 160.

A fan control circuit 164 is provided to enable the server 20 to control the operation of the three-phase DC motor 80. The fourth terminal 142, the fifth terminal 144, and the sixth terminal 146 enable the fan control circuit 164 to communicate with the server 20. The fourth terminal 142 enables the motor controller 112 to receive a fan speed control signal from the server 20. The fan speed control signal is coupled to a processor assembly 166 within the fan control circuit 164. The fan control circuit 164 receives the fan speed control signal from the server 20 and provides a plurality of control signals 160 to the switching circuit 154 to control the opening and closing of the semiconductor switching devices 156 to produce a desired fan speed. The control signals 168 are coupled to circuitry 170 within the switching circuit 154. The circuitry 170 within the switching circuit 154, in turn, provides signals 172 to the semiconductor switching devices 156 to open and close the semiconductor switching devices 156 to produce three-phase DC power.

It has also been discovered that the electrical noise from the plurality of semiconductor switching devices 156 also reduces the efficiency of the three-phase DC motor 80 when the fan control circuit 164 and the plurality of semiconductor switching devices 156 are coupled to a common ground. However, the efficiency of the three-phase DC motor 80 is improved by coupling the fan control circuit 162 to the second ground 160. The fan control circuit 164 receives power from a 5 VDC power supply 174 that is coupled to the 12 VDC bus 152. The 5 VDC power supply supplies power to a 5 VDC (“VDD”) bus 176.

The fifth terminal 144 enables the processor 164 to transmit a tachometer signal to the server 20 to provide an indication of fan speed. The sixth terminal 146 enables the processor 164 to transmit a fault signal to the server 20 when the fan control circuit 162 detects a fault condition. The second terminal, 138, the fourth terminal 142, the 5th terminal, the sixth terminal 146 are electrically coupled to the second ground 160 to prevent electrical noise from the switching circuit 154, e.g., the plurality of semiconductor switching devices 156, from being coupled back to the server 20.

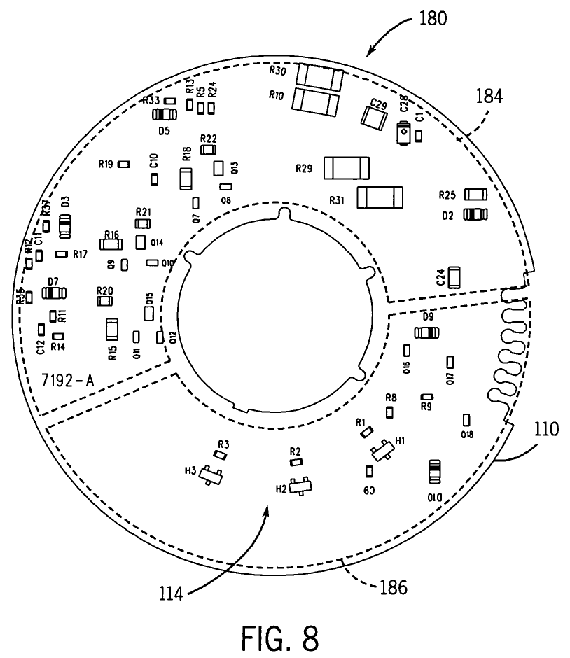

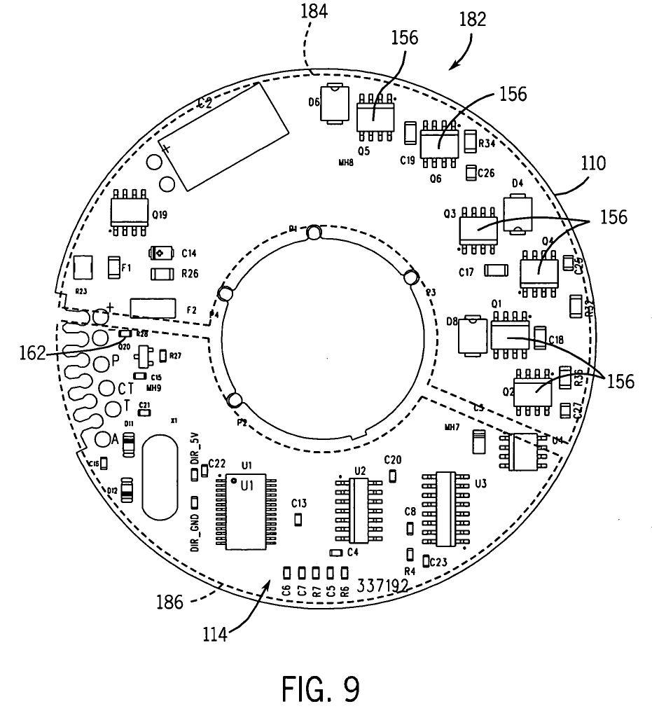

Referring generally to FIGS. 8 and 9, the electronic components 114 of the motor controller 112 may be dispersed between the top surface 180 of the circuit board 110 and the bottom surface 182 of the circuit board 110 in the illustrated embodiment. As noted above, the electronic components 114 of the motor controller 112 are divided into two groups: a first group 184 coupled to the first electrical ground 158 and a second group 186 coupled to the second electrical ground 160. As will be discussed more fully below, the circuit board 110 is configured to prevent the electrical noise generated by the components in the first group 184, e.g., the semiconductor switching devices 156, from interfering with the components in the second group 186, e.g., the processor 164. For example, the first group 184 of components are physically grouped together in one area of the circuit board 110, and the second group 186 of components are physically grouped together in another area of the circuit board 110. Displacing the first group 184 away from the second group 186 reduces the amount of electrical noise transmitted to the second group 186 from the first group 184.

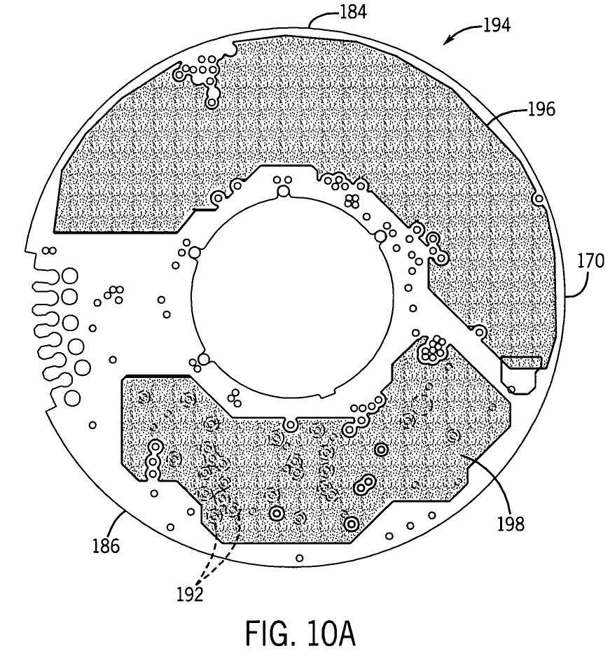

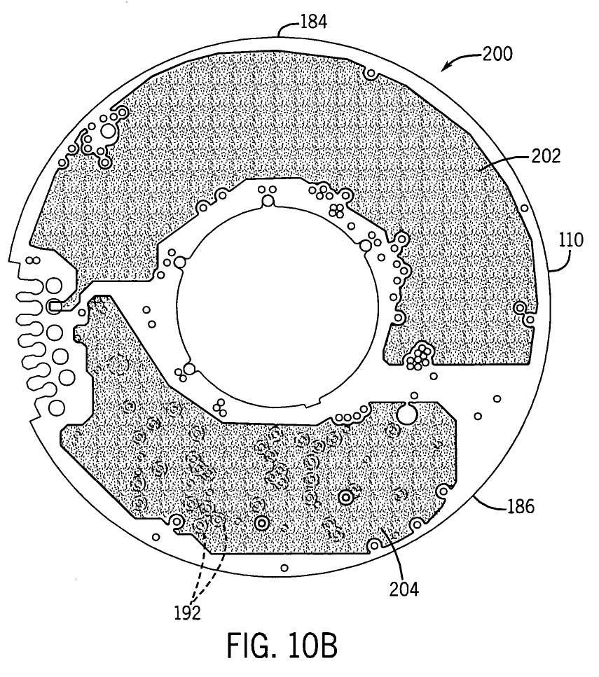

Referring generally to FIGS. 10A and 10B, the circuit board 110 is manufactured to direct electrical noise generated by the first group 184, e.g. the semiconductor switching devices 156, away from the second group 186 of components. In the illustrated embodiment, the circuit board 110 has a plurality of conductive layers that are used to electrically couple the electronic components 114 in the first group 184 and the second group 186. Interspersed between the conductive layers is a layer of an electrically insulating material.

As illustrated in FIG. 10A, the circuit board 110 has a first conductive trace layer 194 that comprises a first conductive plane 196 and a second conductive plane 198. The first conductive plane 196 and the second conductive plane 198 provide common tie points for a plurality of electronic components 114. In the illustrated embodiment, the first conductive plane 196 forms the 12 VDC bus 152 and the second conductive plane 198 forms the 5 VDC bus 176. The large surface area of the conductive planes 196 and 198 lowers their respective electrical resistances as compared to a typical signal trace.

As illustrated in FIG. 10B, the circuit board 110 also comprises a conductive trace layer 200 that comprises a first ground plane 202 and a second ground plane 204. The first ground plane 202 forms the first electrical ground 158, and the second ground plane 204 forms the second electrical ground 160. The first ground plane 202 serves as a shield to block electrical noise generated by the first group 184 of components from reaching the underlying signal traces. In addition, the large surface area of the ground planes also lowers their respective electrical resistances compared to a typical signal trace.

The surface area of the first conductive plane 196 may exceed the area of the first group 184 of components, enabling the first conductive plane 196 to form a shield to block electrical noise generated by the first group 184 of components from reaching the underlying first ground plane 202 or signal traces. Because the second conductive plane 198 is disposed between the second ground plane 204 and the second group 186 of components, the second conductive plane 198 forms a shield to block any electrical noise in the second ground plane 202 from being transmitted to the second group 186 of components.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. An electronic device, comprising:
a redundant, hot-plug cooling fan operable to induce a flow of air through the electronic device, the cooling fan comprising:
a fan impeller; and
a three-phase DC motor coupled to the fan impeller.

2. The electronic device as recited in claim 1, wherein the three-phase DC motor comprises:
a rotor coupled to the fan impeller; and
a stator operable to receive three-phase DC power and produce a magnetic field to induce rotation in the rotor.

3. The electronic device as recited in claim 2, wherein the three-phase DC motor comprises a circuit board having a first ground plane and a second ground plane.

4. The electronic device as recited in claim 3, wherein the three-phase DC motor comprises a plurality of semiconductor switching devices selectively operable to produce three-phase DC power, the plurality of semiconductor switching devices being coupled to ground via the first ground plane.

5. The electronic device as recited in claim 3, wherein the three-phase DC motor comprises a processor coupled to the plurality of semiconductor switching devices to selectively operate the plurality of semiconductor switching devices, the processor being coupled to ground via the second ground plane.

6. The electronic device as recited in claim 3, wherein the second ground plane is electrically isolated from the first ground plane.

7. The electronic device as recited in claim 6, wherein the second ground plane is displaced on the circuit board laterally relative to the first ground plane.

8. The electronic device as recited in claim 5, wherein the circuit board comprises a plurality of terminals to enable the processor to communicate with the electronic device, wherein each of the plurality of terminals is coupled to the second ground plane.

9. The electronic device as recited in claim 8, wherein the processor selectively opens and closes the plurality of semiconductor switching devices in response to control signals received from the electronic device via a first of the plurality of terminals.

10. The electronic device as recited in claim 8, wherein the processor is operable to transmit a signal representative of a cooling fan fault to the electronic device via a second of the plurality of terminals.

11. The electronic device as recited in claim 1, comprising:
a data storage device operable to store programming instructions; and
at least one processor operable to execute the programming instructions, wherein the data storage device and the at least one processor are cooled by the flow of air induced by the cooling fan.

12. The electronic device as recited in claim 11, comprising a second cooling fan, wherein the electronic device selectively operates both cooling fans to produce the flow of air through the electronic device.

13. A cooling fan, comprising:
an impeller;
a three-phase DC motor, comprising:
a rotor mechanically coupled to the impeller;
a stator operable to induce rotation of the rotor;
a circuit board comprising a first electrical ground and a second electrical ground electrically isolated from the first electrical ground;
a plurality of switching devices electrically coupled to the stator, wherein the plurality of switching devices are grounded via the first electrical ground; and
a processor operable to control the plurality of switching devices, wherein the processor is grounded via the second electrical ground.

14. The cooling fan as recited in claim 13, wherein the plurality of switching devices are operable to provide three-phase DC power to the stator.

15. The cooling fan as recited in claim 14, wherein the cooling fan is a hot-pluggable fan comprising a starting circuit operable to slow start the three-phase DC motor.

16. The cooling fan as recited in claim 13, wherein the first electrical ground comprises a first ground plane and the second electrical ground comprises a second ground plane.

17. The cooling fan as recited in claim 16, wherein the plurality of switching devices is displaced on the circuit board laterally relative to the processor.

18. The cooling fan as recited in claim 16, wherein the second ground plane is electrically isolated from the first ground plane by a resistor.

19. The cooling fan as recited in claim 13, wherein the rotor comprises a rare earth magnet.

20. The cooling fan as recited in claim 19, wherein the rare earth magnet comprises bonded neodymium-iron-boron.

21. The cooling fan as recited in claim 19, comprising a fan housing and a bearing assembly to couple the impeller to the fan housing, wherein each bearing in the bearing assembly has an outer diameter that is more than three times the inner diameter of the bearing.

22-26. (canceled)
